(19) United States
(12) Patent Application Publication
(10) Pub. No.: US 2016/0015083 A1
(43) Pub. Date: Jan. 21, 2016

(54) Custom Electric Nail Vaporizing Unit

(71) Applicant: James W. Castillo, Vista, CA (US)

(72) Inventor: James W. Castillo, Vista, CA (US)

(73) Assignee: E-Ceramic Vaporizers Devices LLC, Vista, CA (US)

(21) Appl. No.: 14/802,926

(22) Filed: Jul. 17, 2015

Related U.S. Application Data
(60) Provisional application No. 62/025,941, filed on Jul. 17, 2014.

(51) Int. Cl. A24F 47/00; G10D 1/08

(52) U.S. Cl. CPC A24F 47/008; G10D 1/08

(57) ABSTRACT

An electric nail vaporizing unit comprising a housing including a cavity and an electrical socket, a temperature controller within the cavity of the housing, the temperature controller including a display being integrated into an exterior surface of the housing, and an interconnect, wherein a first end of the interconnect includes a plug that is coupleable to the electrical socket, the electrical socket being in electrical communication with the temperature controller, and a second end of the interconnect is coupleable to a heating coil, the temperature controller configured to pass electric current to the heating coil through the interconnect is shown.

### CROSS-REFERENCE TO RELATED APPLICATIONS

This application claims the benefit of priority on U.S. Application Ser. No. 62/025,941, entitled, “Custom Electric Nail Vaporizing Unit,” filed on Jul. 17, 2014, the contents of which are incorporated by reference.

### FIELD OF THE INVENTION

The field of the present invention generally relates to vaporizers. More particularly, the field of the invention relates to an apparatus and a method for a custom electric nail vaporizing unit which may be installed into housings having aesthetic appeal.

### BACKGROUND

A vaporizer generally is a device utilized to vaporize active ingredients within plant materials, such as cannabis, tobacco, herbs, or herbal blends for the purpose of inhalation. Vaporizers may also be used with pure chemicals without being mixed with plant material (e.g. tobacco-free nicotine). Vaporization is an alternative to burning plant materials so as to avoid inhalation of irritating, toxic, and carcinogenic by-products occurring during inhalation of smoke from burning plant materials.

Vaporizers generally are made of rigid materials, such as metal or glass, and comprise various forms of extraction chambers, including straight bore, venturi, or sequential venturi. In some embodiments, vapor extracted from plant materials may be collected in a jar or an inflatable bag before being inhaled. In other embodiments, extracted vapor may be inhaled directly through a hose or a pipe. Since vaporization produces substantially less smoke and cooler temperatures than does burning plant materials, smaller quantities of plant material is required to achieve a given level of effect, as compared with smoking plant materials. Thus, vaporization gives rise to a reduction of irritation and harmful effects commonly associated with smoking plant materials, as well as a reduction of secondhand smoke.

An electronic cigarette is a well-known variety of vaporizer comprising a battery-powered vaporizer which simulates tobacco smoking by producing a vapor that resembles smoke. Typically, an electric cigarette comprises a heating element, known as an atomizer, which vaporizes a liquid solution called an e-liquid. In some embodiments, e-liquids comprise a mixture of propylene glycol, vegetable glycerin, nicotine, and flavorings. In other embodiments, however, the nicotine may be omitted from the mixture.

Vaporizers are also commonly used to inhale cannabis for therapeutic purposes, such as reduction of chronic pain due to multiple sclerosis, epilepsy, HIV/AIDS, and other chronic ailments and diseases. Some studies have indicated that smoking cannabis sativa may substantially reduce daily pain in patients. Other studies have shown that vaporizing cannabis exposes the user to lower levels of harmful substances than inhaling smoke from burning cannabis.

### SUMMARY

An apparatus for vaporizing a substance placed on a holding unit of the apparatus is provided. The apparatus comprises a housing that includes at least a cavity and an electrical socket, a temperature controller that is located within or integrated into the housing, and an interconnect that includes a first end and a second end. The first end includes a plug that is configured to couple with the electrical socket of the housing and the second end of the interconnect includes a heating coil. When the interconnect is coupled to the electrical socket, electrical current is passed through the interconnect to the heating coil. The heating coil receives the electrical current and subsequently heats up. The heat is then transferred to the holding unit that is coupled to the heating coil. The substance within the holding unit is heated to a high temperature such that vapors are produced. The vapors are directed through a vaporizer and subsequently may be inhaled.

In an exemplary embodiment, an electric nail vaporizing unit comprises a housing including a cavity and an electrical socket; a temperature controller within the cavity of the housing, the temperature controller including a display being integrated into an exterior surface of the housing; and an interconnect, wherein a first end of the interconnect includes a plug that is coupleable to the electrical socket, the electrical socket being in electrical communication with the temperature controller, and a second end of the interconnect is coupleable to a heating coil, the temperature controller configured to pass electric current to the heating coil through the interconnect.

In an exemplary embodiment, the electric nail vaporizing unit further comprises a holding unit to hold a substance to vaporize, wherein the heating coil is configured to couple with the holding unit. In an exemplary embodiment, the electric nail vaporizing unit further comprises a vaporizer that is coupleable with the holding unit, wherein a vapor of the substance is directed through the vaporizer so that the vapor may be inhaled. In an exemplary embodiment, the electric nail vaporizing unit comprises an atomizer that vaporizes an e-liquid stored in a tank so as to simulate a smoking experience without vaporizing plant materials.

In an exemplary embodiment, the interconnect is an electric conduit including a heat resistant sleeving. In an exemplary embodiment, the substance is a plant-based material. In an exemplary embodiment, the temperature controller is a proportional-integral-derivative (PID) controller that utilizes a control loop feedback mechanism to control a level of electric current passed to the heating coil. In an exemplary embodiment, passing the electric current from the temperature controller through the interconnect increases a temperature of the heating coil. In an exemplary embodiment, the temperature controller is capable of passing electric current through the interconnect to heat the heating coil to 1100 degrees Fahrenheit.

In an exemplary embodiment, the housing includes a second electrical socket. In an exemplary embodiment, the electric nail vaporizing unit further comprises a second temperature controller including a second display being integrated into a second exterior surface of the housing; and a second interconnect, wherein a first end of the second interconnect includes a second plug that is coupleable to the second electrical socket, the second electrical socket being in electrical communication with the second temperature controller, and a second end of the second interconnect is coupleable to a second heating coil, the second temperature controller configured to pass electric current to the second heating coil through the second interconnect. In an exemplary embodiment, the temperature controller is controllable by one or more signals received transmitted via a wireless medium.

In an exemplary embodiment, the housing is a musical instrument. In an exemplary embodiment, the musical instrument is a guitar. In an exemplary embodiment, the housing is a Hawaiian gourd. In an exemplary embodiment, the housing is a piece of furniture. In an exemplary embodiment, the housing includes a plurality of storage units and a lock to lock the storage units. In an exemplary embodiment, the housing includes one or more lights.

In an exemplary embodiment, a system for inhaling vapors comprises a temperature controller housed within a chamber, the chamber including a first socket electrically coupled to the temperature controller; an electric interconnect electrically coupleable to the first socket at a first end of the electric interconnect and to (i) receive current from the temperature controller and (ii) pass the electric current to a heating coil coupled to a second end of the electrical interconnect, wherein the electric current heats an exterior surface of the heating coil; a holding unit coupleable to the heating coil to (i) receive heat from the heating coil, and (ii) heat a substance placed within the holding unit thereby creating a vapor. In an exemplary embodiment, the system further comprises a vaporizer that is coupleable with the holding unit, wherein the vapor of the heated substance is directed through the vaporizer so that the vapor may be inhaled.

### BRIEF DESCRIPTION OF THE DRAWINGS

The disclosure may best be understood by referring to the following description and accompanying drawings that are used to illustrate embodiments of the disclosure.

FIG. 1 illustrates an embodiment of an electric nail vaporizing unit installed into a housing having a cavity.

FIG. 2 illustrates a second embodiment of a custom electric nail vaporizing unit installed into a housing.

FIG. 3 illustrates an embodiment of an electric nail vaporizing unit installed into a guitar.

FIG. 4 illustrates a second embodiment of an electric nail vaporizing unit installed in a Hawaiian ipu gourd.

FIG. 5 illustrates an embodiment of a handle, electric conduit and heating coil.

FIG. 6 illustrates an exemplary use environment wherein an electric nail vaporizing unit is utilized in accordance with the present invention.

FIG. 7 illustrates a custom electric nail vaporizing unit installed into a piece of furniture.

FIG. 8 illustrates a custom electric nail vaporizing unit installed into a foldable box.

FIG. 9 illustrates a custom electric nail vaporizing unit installed into a solid box.

FIG. 10 illustrates a first embodiment of a temperature controller that may be utilized in conjunction with an electric nail vaporizing unit.

FIG. 11 illustrates a second embodiment of a temperature controller that may be utilized in conjunction with an electric nail vaporizing unit.

FIG. 12 illustrates a third embodiment of a temperature controller that may be utilized in conjunction with an electric nail vaporizing unit.

FIG. 13 illustrates a fourth embodiment of a temperature controller that may be utilized in conjunction with an electric nail vaporizing unit.

FIG. 14 illustrates a fifth embodiment of a temperature controller that may be utilized in conjunction with an electric nail vaporizing unit.

FIG. 15 illustrates a sixth embodiment of a temperature controller that may be utilized in conjunction with an electric nail vaporizing unit.

FIG. 16 illustrates a seventh embodiment of a temperature controller that may be utilized in conjunction with an electric nail vaporizing unit.

FIG. 17 illustrates an embodiment of a temperature controller which is integrated into a Hawaiian ipu gourd, according to the present invention.

### DETAILED DESCRIPTION

Embodiments of the disclosure relate to electronic vaporizer units, wherein an electric conduit may transfer electric current from an electrical socket to a heating coil that heats a substance creating a vapor that may be inhaled.

While the present invention is subject to various modifications and alternative forms, specific embodiments thereof have been shown by way of example in the drawings and will herein be described in detail. The invention should be understood to not be limited to the particular forms disclosed, but on the contrary, the intention is to cover all modifications, equivalents, and alternatives falling within the spirit and scope of the present invention.

In the following description, numerous specific details are set forth in order to provide a thorough understanding of the present invention. It will be apparent, however, to one of ordinary skill in the art that the present invention may be practiced without these specific details. In other instances, well known components or methods have not been described in detail but rather in a block diagram, or a schematic, in order to avoid unnecessarily obscuring the present invention. Further specific numeric references such as “first item,” may be made. However, the specific numeric reference should not be interpreted as a literal sequential order but rather interpreted that the “first item” is different than a “second item.” Thus, the specific details set forth are merely exemplary. The specific details may be varied from and still be contemplated to be within the spirit and scope of the present invention. The term “coupled” should be interpreted as meaning two or more items are connected either directly to the component or indirectly to the component through another component. In addition, the coupling may physical, electric, fluid, communicative, etc.

In general, the present disclosure describes an apparatus and a method for a custom electric nail vaporizing unit installed into various housings having aesthetic appeal to an end-user. One or more of the figures illustrate various embodiments of a custom electric nail vaporizing unit that is installed into various aesthetically appealing objects. In some embodiments, the aesthetically appealing objects may each comprise a surface decoration, such as a detailed graphic design. In some embodiments, the aesthetically appealing objects may comprise hydrographic wraps.

An electric nail vaporizing unit uses conduction to produce a vapor, which a user may inhale. Typically, a coil is heated to a high temperature, e.g., 900 to 1000 degrees Fahrenheit, and a “nail” (e.g., a holding unit) is placed in contact with the heated coil. The heat of the coil is transferred to the nail, which heats a substance stored in the nail. For example, the substance may be a plant material such as cannabis or tobacco, which may be in the form of a paste. However, other temperatures may be used depending on the substance, form of substance, strain of plant material used, etc. In one embodiment, the substance may be heated to a temperature of 710 degrees Fahrenheit. Alternatively, other embodiments may utilize a liquid, wherein the liquid is heated to a much lower temperature, e.g., between 350-400 degrees Fahrenheit.

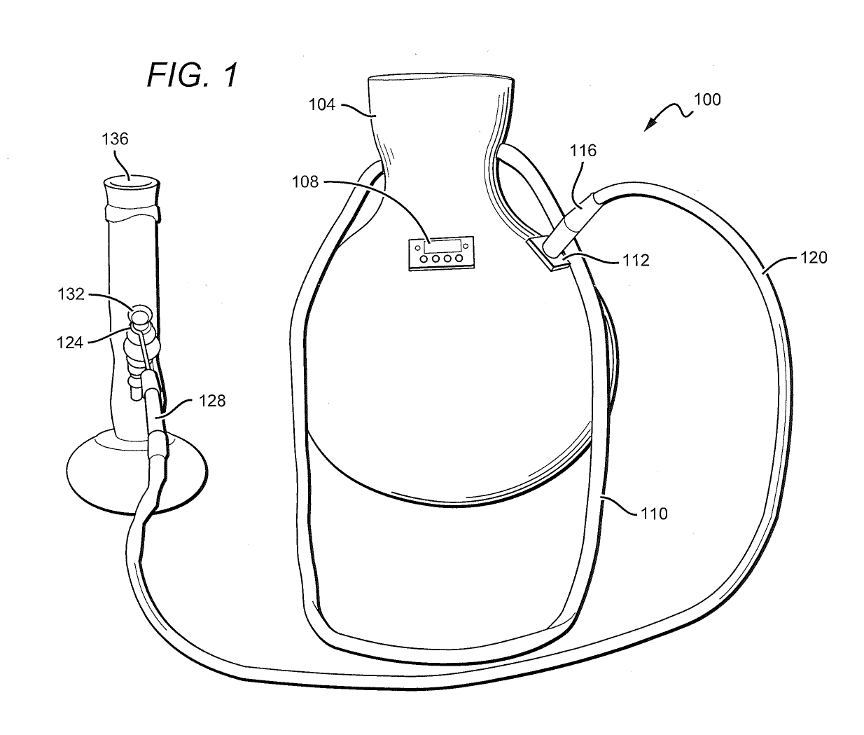

Referring to FIG. 1, an embodiment of a custom electric nail vaporizing unit is installed into a housing having a cavity is shown. In FIG. 1, the custom electric nail vaporizing unit 100 (hereinafter “vaporing unit”) is installed into a Hawaiian ipu gourd 104 (hereinafter “gourd”). The vaporizing unit 100 includes the gourd 104, a temperature controller 108, a carrying string 110, an electrical socket 112, a plug 116, an electric conduit 120, a heating coil 124, a handle 128, a nail 132 and a vaporizer 136.

A Hawaiian ipu gourd, the fruit of a plant traditionally grown in Hawaii and used as food and for medicinal and artistic purposes, is merely one example of a housing that may be utilized in the electric nail vaporizing unit. The gourd 104 provides a functionality such as storing electronic circuitry that supplies an electric conduit (e.g., an interconnect) with electric current. As will be discussed below, numerous other items may be used in place of the gourd 104.

The gourd 104 illustrated in FIG. 1 includes the temperature controller 108, which allows a user to adjust the temperature of the heating coil 124. The temperature controller 108 is illustrated as a digital screen which provides an easy-to-read display to a user. However, other embodiments of the temperature controller 108 have been envisioned such as an adjustable knob. The gourd 104 includes electronic circuitry, not shown, within the gourd itself. The circuitry is electrically coupled to the temperature controller 108 such that when then temperature controller 108 is adjusted, the electric current provided by the electrical socket 112 is adjusted accordingly. For example, when a user adjusts the temperature controller 108 to display 850 degrees Fahrenheit, the temperature controller 108 provides the electric conduit 116 with the appropriate electric current in order to heat the heating coil 124 to 850 degrees Fahrenheit.

Upon receiving an electric current via the electrical conduit 124, the temperature of heating coil 124 increases. The nail 132 is placed in the heating coil 124 and, subsequently, the nail 132 is heated. The nail 132 holds a substance the vapors of which a user may inhale, for example, through a vaporizer. When the nail 132 reaches the desired temperature, the substance placed in the nail 132 is brought to its boiling temperature. Subsequently, as a user inhales through the vaporizer 136, the substance begins to dehydrate and the yield of the substance is released into the air and is inhaled by the user via the vaporizer 136. Examples of substances that may be placed in the nail 132 include, but are not limited or restricted to, tobacco, Shisha, mu'assel, vapor stones, nicotine, cannabis, etc.

In one embodiment, the gourd 104 may include a plurality of sockets 112 that may receive a plurality of plugs 116. In such an embodiment, the plurality of plugs 116 plugged into the plurality of sockets 112 would enable a plurality of nails to be heated simultaneously, thereby allowing a plurality of users to utilize a plurality of vaporizers simultaneously.

In one embodiment, the temperature controller 108 may regulate the temperature of the nail 132 using one or more microcontrollers. One or more of the microcontrollers may provide digital signals to a digital display on which the current temperature on one or more nails 132 is displayed. The digital display may be part of a temperature controller (e.g., a proportional-integral-derivative (PID) controller), as will be discussed below. In some embodiments, the electric conduit 120 may include a protective sleeving that may be heat resistant and/or flame retardant. For example, the protective sleeving may be a Aramid Armor cord sleeving (i.e., a tightly woven sleeving braided from aramid fibers).

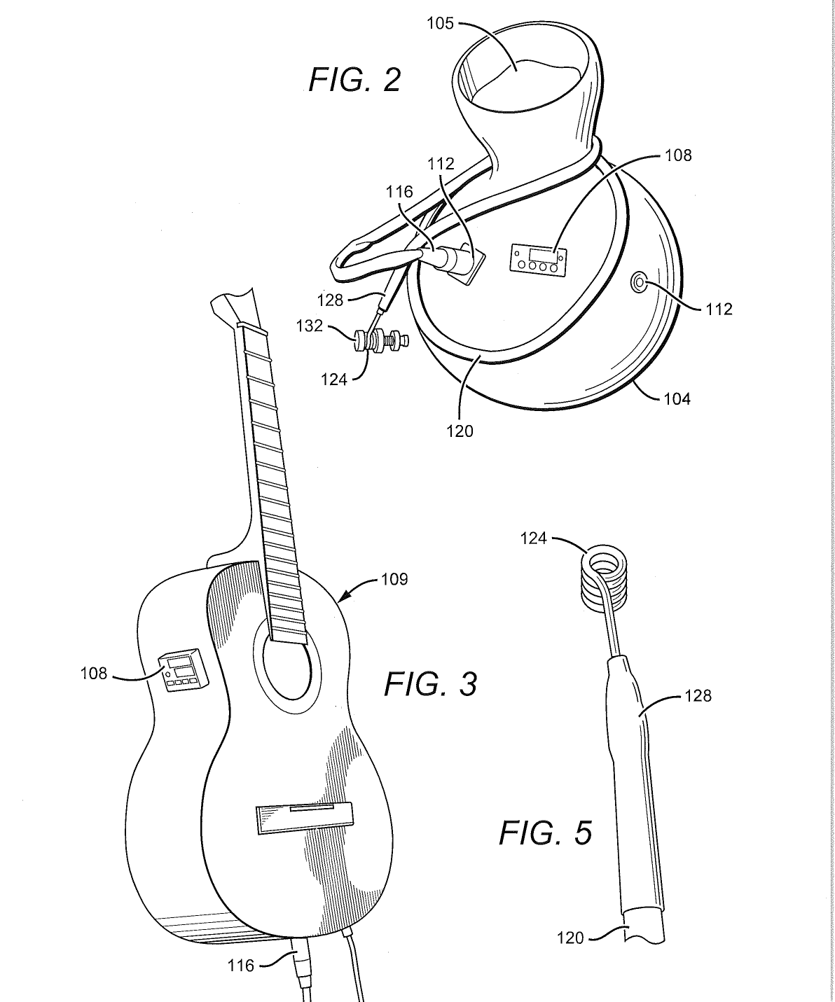

Referring to FIG. 2, a second embodiment of a custom electric nail vaporizing unit installed into a housing is shown. The embodiment illustrated in FIG. 2 is substantially similar to the embodiment of FIG. 1; however, the gourd 104 of FIG. 2 has different natural characteristics (e.g., shape, size, color) than the gourd of FIG. 1. In addition, the gourd 104 of FIG. 2 comprises a light 105 at a top, open portion of the gourd 104. The light 105 may comprise one or more light emitting diodes (LEDs). In one or more embodiments, the light 105 may be a specific color, may change color in a predetermined pattern (e.g., rotate colors at predefined intervals) and/or may be programmed to alternate colors according to music. It should be recognized that the wires and electrical components necessary to convey electrical power to the light 105 and, as mentioned above, the components comprising the custom electric nail vaporizing unit preferably are housed within the gourd 104, and thus are not visible from outside of the gourd. The gourd 104 of FIG. 2 illustrates an embodiment in which two sockets 112 are present.

Referring to FIG. 3, an embodiment of an electric nail vaporizing unit installed into a guitar is shown. In one embodiment, the guitar 109 may be an acoustic guitar. Similar to the embodiments illustrated in FIGS. 1 and 2, the guitar 109 houses wires and components of the custom electric nail vaporizing unit so as to give the guitar an aesthetically appealing appearance. It should be understood that the guitar 109 may be a fully operable guitar in spite of the presence of the installed custom electric nail vaporizing unit. In one embodiment, although not shown, the guitar 109 may include a silicone mat may be incorporated into a surface of the guitar 109 to provide an area on which to place the substance to be placed in the nail 132. The incorporation of the silicone mat prevents any damage to the housing (e.g., a guitar, a ipu gourd, etc.).

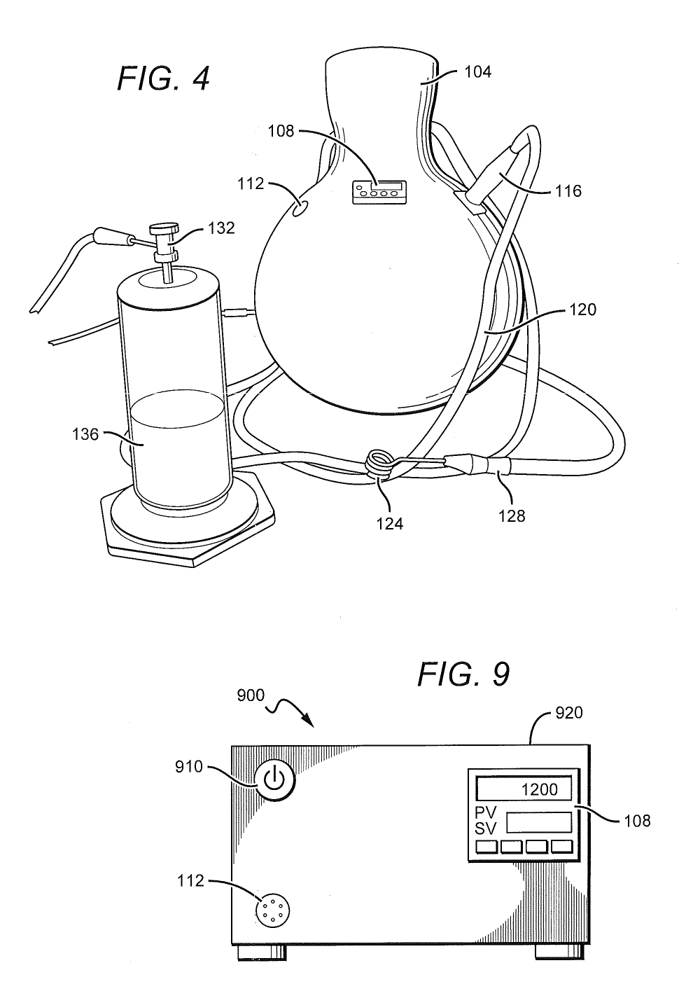

Referring to FIG. 4, a second embodiment of an electric nail vaporizing unit installed in a Hawaiian ipu gourd is shown. The embodiment illustrated in FIG. 4 is substantially similar to the embodiment illustrated in FIG. 1, with the exception that some of the components comprising the custom electric nail vaporizing unit have a slightly different form than those shown in FIG. 1. It should be understood, however, that the operation of the custom electric nail vaporizing unit illustrated in FIGS. 1-4 is substantially the same, and thus only the shapes and appearance of some components and the housing are unique to each embodiment.

Referring to FIG. 5, one example of a handle, electric conduit and heating coil is shown. The electric conduct 120 is shown as having a protective sleeving, e.g., an Aramid Amor cord sleeving. The handle 128 is shown to provide a covering over the coupling of the electric conduit 120 and the heating coil 124. In some embodiments, the handle 128 may be outfitted with one or more customizable designs. The heating coil 124 is configured to receive a nail 132 of a vaporizer 136. The handle 128 facilitates the end-user touching or grasping an end of the electric conduit 120 opposite the plug 116 while the heating coil 124 is hot. In an embodiment, the heating coil 124 comprises a heating coil capable of reaching a temperature of 1100 degrees, and the electric conduit 120 comprises an exterior protective sheath (e.g., sleeving) capable of withstanding temperatures up to 1200 degrees.

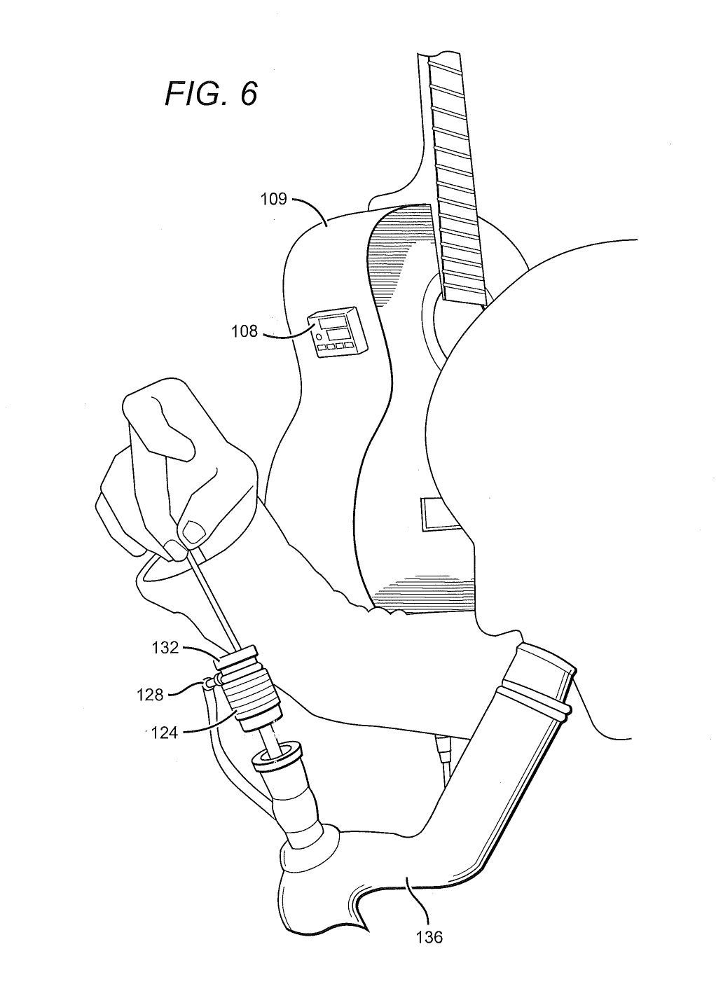

Referring to FIG. 6, an exemplary use environment of an electric nail vaporizing unit is shown. During operation of the electric nail vaporizing unit, the temperature controller 108 is used to pass an electric current through the electric conduit 120 to the heating coil 124. Subsequently, the surface temperature of the heating coil 124 increases so as raise the surface temperature of the nail 132. As the surface temperature of the nail 132 rises, the substance in the nail 132 (e.g., plant materials) begins to vaporize. The end-user may inhale resultant vapors from the nail 132 through the vaporizer 136. In other embodiments, however, the nail 132 may be omitted in favor of an atomizer, which vaporizes an e-liquid stored in a tank so as to simulate a smoking experience without vaporizing plant materials.

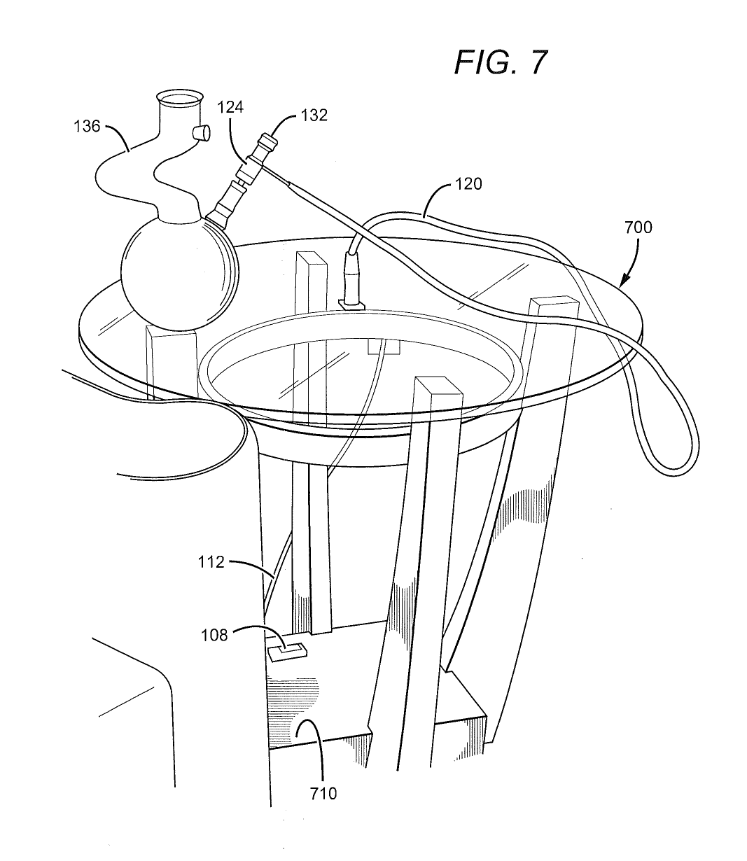

Referring to FIG. 7, a custom electric nail vaporizing unit installed into a piece of furniture is shown. In the embodiment of FIG. 7, the piece of furniture is illustrated as a table 700 and the temperature controller 108 is integrated into the base 710 of the table 700. Similarly, the socket 112 is located at the base 710 of the table 700 and the electric conduit 120 is seen to extend from the base 710 to the handle 128. Such an embodiment leaves enables one or more users to utilize the technology of an electric nail vaporizing unit while maintaining the top surface of the table 1700 substantially free from objects. It should be noted that other types of furniture may take the place of the table. Examples may include, but are not limited or restricted to, a table, an ottoman, a coffee table, a dining table, a standalone bar, a counter, etc.

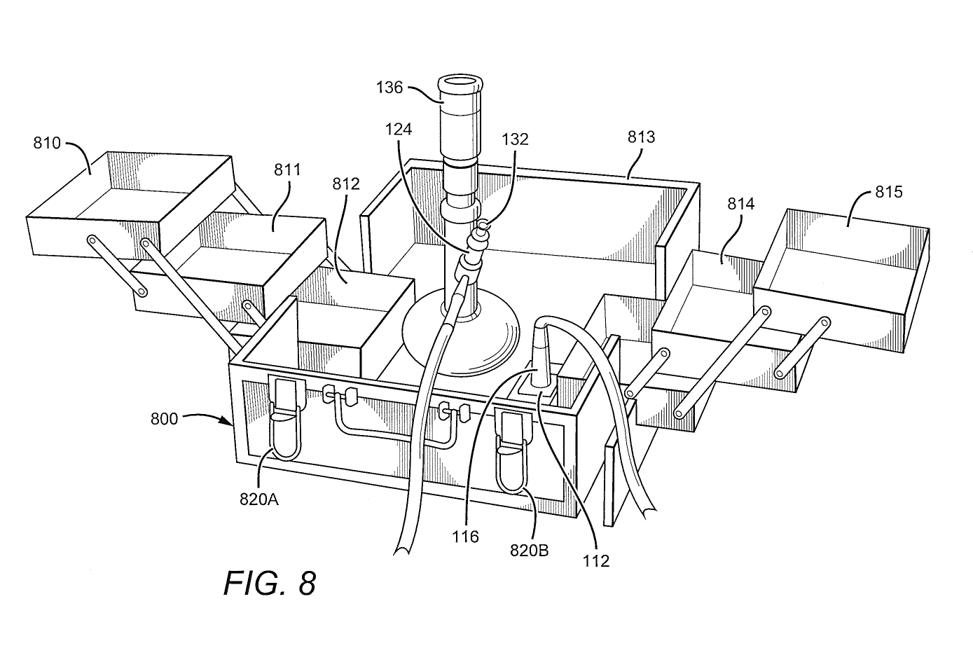

Referring to FIG. 8, a custom electric nail vaporizing unit installed into a foldable box is shown. The foldable box 800 includes a plurality of foldable shelves 810-815. The box 800 may also include one or more sockets 112 and locks 820A and 820B. The foldable shelves 810-815 plurality storage for accessories (e.g., nails 132, electric conduits 120, substances to place in the nails 132, etc.). As is illustrated, a vaporizer 136 may be placed in the base of the box 800 and a plug 116 may be received by the socket 112. The box 800 may include more or less shelves. Furthermore, the box may be decorated in any fashion including wrapped and/or painted. Additionally, the box 800 may include one or more lights (e.g., LEDs).

Referring to FIG. 9, a custom electric nail vaporizing unit installed into a solid box is shown. The box 900 may include a power button 900, an silicone mat 920, one or more sockets 112, a temperature controller 108. The box 900 may be comprised of various materials including, but not limited or restricted to, metal (e.g., steel, aluminum, etc.), wood, glass, plastic or a combination thereof. Although not shown, the box 900 may include one or more lights (e.g., LEDs), which may alternate in color, as discussed above.

In some embodiments, the housing (e.g., the gourd 104, guitar 109, table 700, box 800 and box 900), may be outfitted with more than one temperature controllers 108, thereby enabling multiple end-users to control the temperature of each individual heating coil 124. By controlling the temperature of each individual heating coil 124, different substances having varied recommended vaporizing temperatures may be placed in one or more nails 132, which are heated by the plurality of individual heating coils 124.

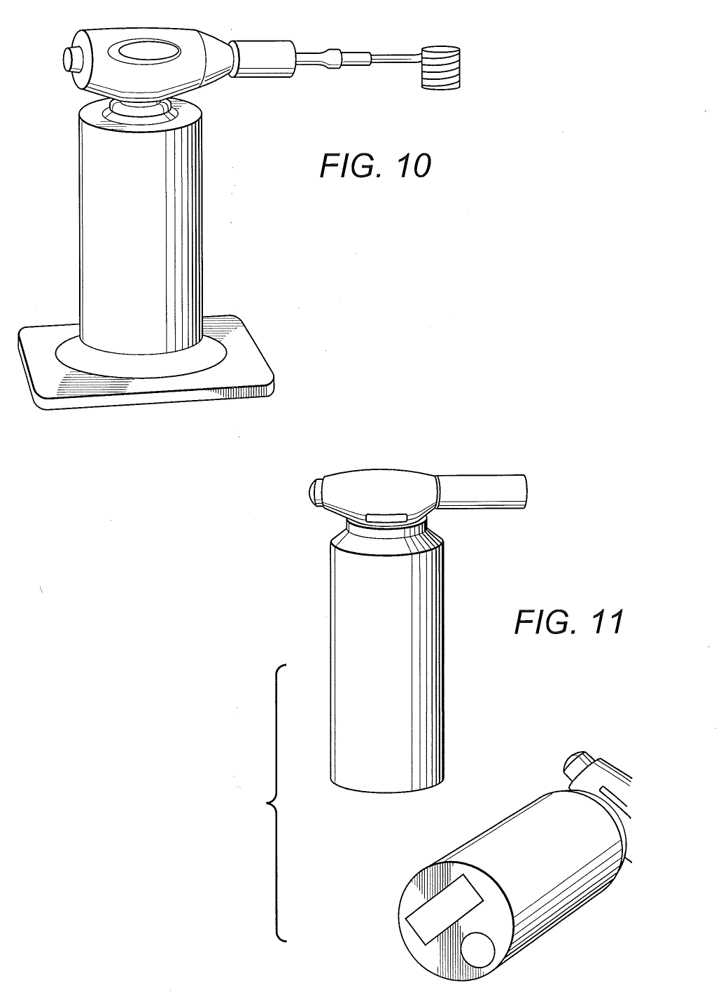

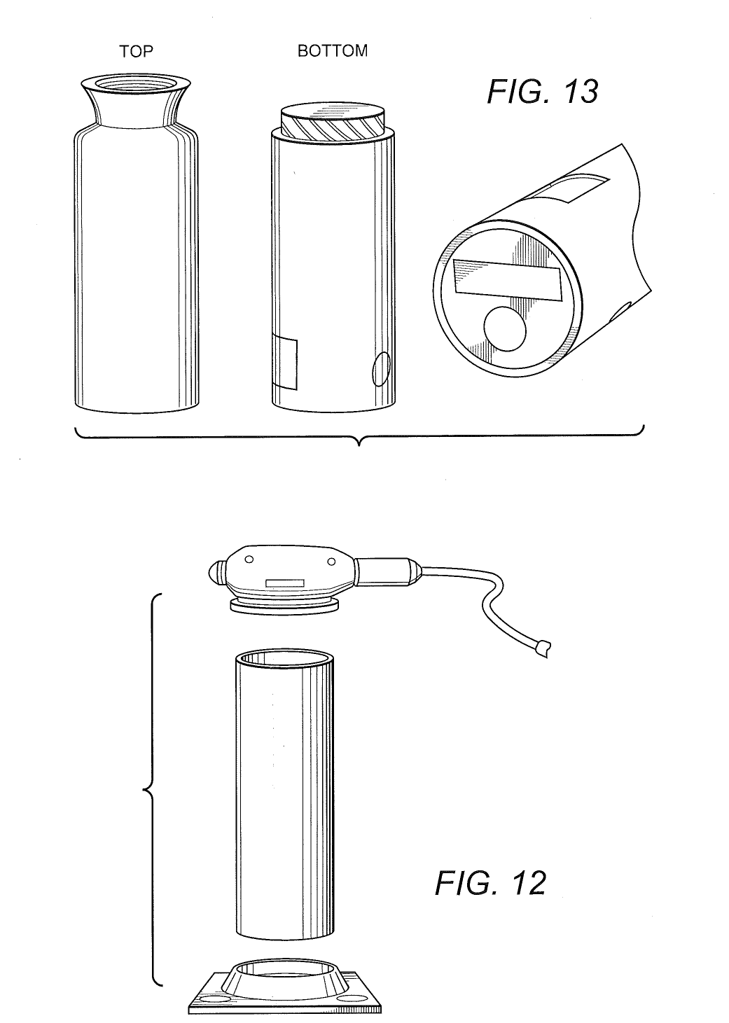

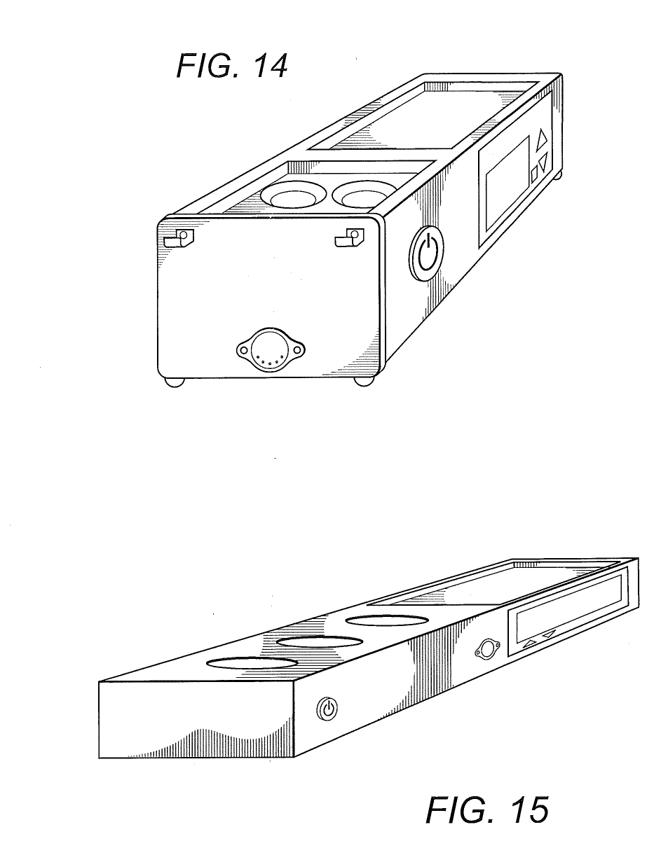

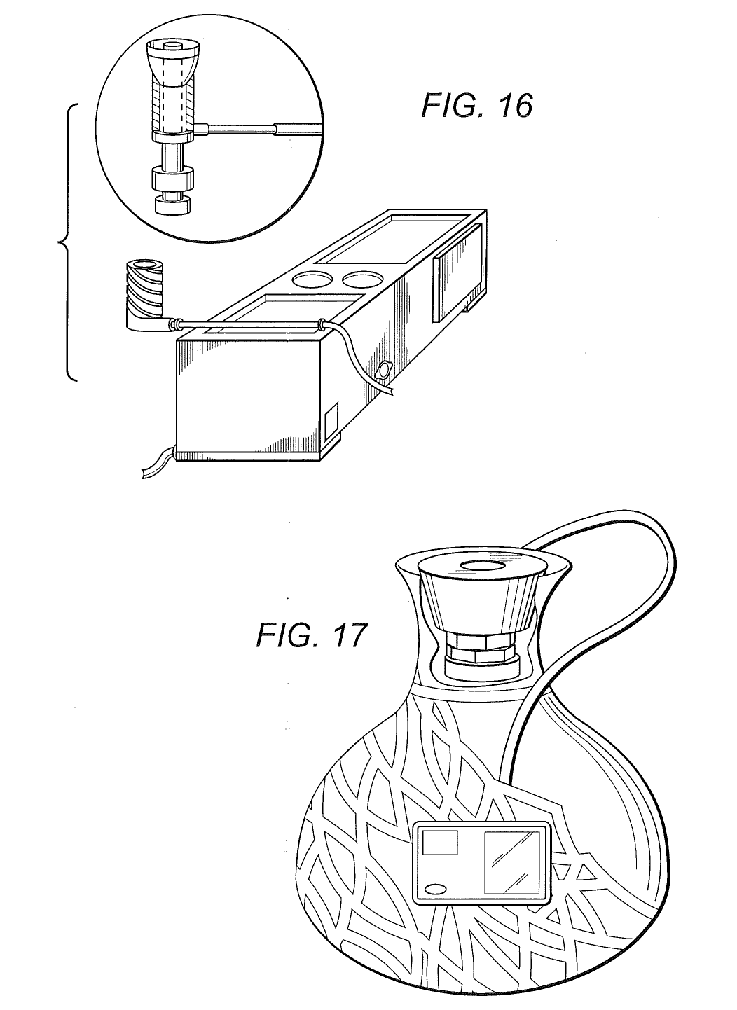

As will be appreciated by those skilled in the art, the temperature controller 108 enables the end-user to control the level of electric current passed through the electric conduit 120 and the heating coil 124 so as to control the temperature conveyed to the nail 132 and the substance(s) placed therein. Preferably, the temperature controller 108 is a PID controller which utilizes a control loop feedback mechanism to control the level of electric current passed to the heating coil 124. In an embodiment, the temperature controller 108 comprises multiple settings and at least one display whereby the end-user may control at least the temperature imparted to the nail 132. In another embodiment, the temperature controller 108 is configured to be controlled via signals received over a wireless medium, e.g., using Wireless Local Area Network (WLAN) technologies compliant with one or more standards such as the Institute of Electrical and Electronics Engineers (IEEE) 802.11 standard, and thus may be operated by way of a Wi-Fi compatible device, such as by way of non-limiting example, a cell phone, a mobile computer, or other similar wireless device. Moreover, the temperature controller 108 need not be limited to the shapes illustrated in FIGS. 1-9. Rather, the temperature controller 108 may be implemented in a wide variety of shapes and sizes, such as those shapes illustrated in FIGS. 10-16. Furthermore, in some embodiments, the temperature controller 108 may be integrated into housings, rather than merely fastened to the exterior of the housings, so as to minimize visibility of electrical components exterior to the housing. For example, FIG. 17 illustrates an embodiment wherein the temperature controller 108 is integrated into the gourd 104, such that a mechanical envelop of the temperature controller is housed within the volume of the gourd 104, and thus is not visible from outside of the gourd. Furthermore, as illustrated in FIG. 14, the housing may include one or more plugs (e.g., universal serial bus (USB) plus, Lightning connector plug, etc.) which may be used to couple an electronic device (e.g., a mobile phone or a tablet) to the housing. The one or more plugs may serve to charge the electronic device and/or link the electronic device to the one or more microcontrollers.

While some specific embodiments of the present invention have been shown the invention is not to be limited to these embodiments. For example, most functions performed by electronic hardware components may be duplicated by software emulation. Thus, a software program written to accomplish those same functions may emulate the functionality of the hardware components in input-output circuitry. The present invention is to be understood as not limited by the specific embodiments described herein, but only by scope of the appended claims.

What is claimed is:

1. An electric nail vaporizing unit comprising:
a housing including a cavity and an electrical socket;
a temperature controller within the cavity of the housing, the temperature controller including a display being integrated into an exterior surface of the housing; and
an interconnect, wherein a first end of the interconnect includes a plug that is coupleable to the electrical socket, the electrical socket being in electrical communication with the temperature controller, and a second end of the interconnect is coupleable to a heating coil, the temperature controller configured to pass electric current to the heating coil through the interconnect.

2. The electric nail vaporizing unit of claim 1 further comprising:
a holding unit to hold a substance to vaporize, wherein the heating coil is configured to couple with the holding unit.

3. The electric nail vaporizing unit of claim 2 further comprising:
a vaporizer that is coupleable with the holding unit, wherein a vapor of the substance is directed through the vaporizer so that the vapor may be inhaled.

4. The electric nail vaporizing unit of claim 2 further comprising:
an atomizer that vaporizes an e-liquid stored in a tank so as to simulate a smoking experience without vaporizing plant materials.

5. The electric nail vaporizing unit of claim 1, wherein the interconnect is an electric conduit including a heat resistant sleeving.

6. The electric nail vaporizing unit of claim 2, wherein the substance is a plant-based material.

7. The electric nail vaporizing unit of claim 1, wherein the temperature controller is a proportional-integral-derivative (PID) controller that utilizes a control loop feedback mechanism to control a level of electric current passed to the heating coil.

8. The electric nail vaporizing unit of claim 1, wherein passing electric current from the temperature controller through the interconnect increases a temperature of the heating coil.

9. The electric nail vaporizing unit of claim 1, wherein the temperature controller is capable of passing electric current through the interconnect to heat the heating coil to 1100 degrees Fahrenheit.

10. The electric nail vaporizing unit of claim 1, wherein the housing includes a second electrical socket.

11. The electric nail vaporizing unit of claim 10 further comprising:
a second temperature controller including a second display being integrated into a second exterior surface of the housing; and
a second interconnect, wherein a first end of the second interconnect includes a second plug that is coupleable to the second electrical socket, the second electrical socket being in electrical communication with the second temperature controller, and a second end of the second interconnect is coupleable to a second heating coil, the second temperature controller configured to pass electric current to the second heating coil through the second interconnect.

12. The electric nail vaporizing unit of claim 1, wherein the temperature controller is controllable by one or more signals received transmitted via a wireless medium.

13. The electric nail vaporizing unit of claim 1, wherein the housing is a musical instrument.

14. The electric nail vaporizing unit of claim 13, wherein the musical instrument is a guitar.

15. The electric nail vaporizing unit of claim 1, wherein the housing is a Hawaiian gourd.

16. The electric nail vaporizing unit of claim 1, wherein the housing is a piece of furniture.

17. The electric nail vaporizing unit of claim 1, wherein the housing includes a plurality of storage units and a lock to lock the storage units.

18. The electric nail vaporizing unit of claim 1, wherein the housing includes one or more lights.

19. A system for inhaling vapors comprising:
a temperature controller housed within a chamber, the chamber including a first socket electrically coupled to the temperature controller;
an electric interconnect electrically coupleable to the first socket at a first end of the electric interconnect and to (i) receive current from the temperature controller and (ii) pass the electric current to a heating coil coupled to a second end of the electrical interconnect, wherein the electric current heats an exterior surface of the heating coil;
a holding unit coupleable to the heating coil to (i) receive heat from the heating coil, and (ii) heat a substance placed within the holding unit thereby creating a vapor.

20. The system of claim 19 further comprising:
a vaporizer that is coupleable with the holding unit, wherein the vapor of the heated substance is directed through the vaporizer so that the vapor may be inhaled.
